(19) United States
(12) Patent Application Publication
(10) Pub. No.: US 2015/0073604 A1
(43) Pub. Date: Mar. 12, 2015

(54) AIR CONDITIONER PANEL SEMICONDUCTOR DEVICE AND VEHICLE AIR CONDITIONER SYSTEM HAVING THE SAME

(71) Applicant: Hyundai Motor Company, Seoul (KR)

(72) Inventor: Kyu Sang Ro, Seoul (KR)

(73) Assignee: Hyundai Motor Company, Seoul (KR)

(21) Appl. No.: 14/138,886

(22) Filed: Dec. 23, 2013

(30) Foreign Application Priority Data
Sep. 6, 2013 (KR) 10-2013-0107494

(51) Int. Cl. F24F 11/00; B60H 1/00

(52) U.S. Cl. CPC F24F 11/0086; B60H 1/00985; F24F 2011/0091
USPC 700/276

(57) ABSTRACT

An air-conditioning panel semiconductor device and an air-conditioning system including the same are provided. The device includes a controller that integrally operates analog modules and digital modules in the air-conditioning panel semiconductor device, operates a motor in an air-conditioning duct, and operates an LCD (Liquid Crystal Display) to display operation state information of an air conditioner for the vehicle on the screen of an air-conditioning panel. An SPI transmits and receives signals relating to air-conditioning by connecting the controller with an external peripheral device. A LIN communication module electrically connected with a main controller to operate the air conditioner. The controller supplies power for the modules in the air-conditioning panel semiconductor device at a substantially uniform voltage by operating a voltage regulator.

### CROSS-REFERENCE TO RELATED APPLICATION

This application claims priority to and the benefit of Korean Patent Application No. 10-2013-0107494 filed in the Korean Intellectual Property Office on Sep. 6, 2013, the entire contents of which are incorporated herein by reference.

### BACKGROUND

(a) Field of the Invention

The present invention relates to an air-conditioning panel semiconductor device and an air-conditioning system for a vehicle having the same.

(b) Description of the Related Art

Air-conditioning controllers for vehicles of the related art are configured by combining a panel with a main controller and using analog parts and digital parts for the various types of vehicles. FIG. 1 is an exemplary block diagram showing the configuration integrating a liquid crystal display (LCD) panel controller and a main controller for the type of a vehicle of the related art.

Referring to FIG. 1, the air-conditioning controller for a vehicle of the related art is composed of the parts of an LCD driver, a MICOM, a motor driver, and low drop output (LDO) regulator, a control area network (CAN) driver, and other analog transceivers. The controller is configured to operate a motor in an air-conditioning duct, display an image on an LCD display window, and adjust engine loads by transmitting and receiving information to and from an engine ECU (Engine Control Unit) and a cluster via CAN communication. However, the development and verification of a new air-conditioning controller for each type of vehicle is time consuming and costly, and the number of types of air-conditioning controllers for the types of vehicles is constantly increasing. Further, use of an integral controller causes package space limitations due to an increase in size of the controller and the functions increase due to quality enhancement of the specifications for the types of vehicles, such that the numbers of parts and interface circuits increase, and thus, the controller increases in size.

The above information disclosed in this section is merely for enhancement of understanding of the background of the invention and therefore it may contain information that does not form the prior art that is already known in this country to a person of ordinary skill in the art.

### SUMMARY

The present invention provides an air-conditioning panel semiconductor device formed by integrating an LDO, and LCD DR, and a Local Interconnect Network transceiver (LIN TR), which are analog semiconductors, with a MICOM that is a digital semiconductor, which may be included in an air-conditioning panel for a vehicle, and an air-conditioning system for a vehicle including the semiconductor device.

An exemplary embodiment of the present invention provides an air-conditioning panel semiconductor device that operates an air-conditioning panel for a vehicle and the device may include: a controller configured to integrally operate analog modules and digital modules in the air-conditioning panel semiconductor device; a motor driver executed by the controller to operate a motor in an air-conditioning duct i; an LCD (Liquid Crystal Display) driver executed by the controller to display operation state information of an air conditioner for a vehicle on the screen of an air-conditioning panel; an SPI (Serial Peripheral Interface Bus) configured to transmit and receive signals that relate to air-conditioning by connecting the controller with an external peripheral device; and an LIN (Local Interconnect Network) transceiver electrically connected with a main controller that operates the air conditioner, in which the controller may supply power for the modules in the air-conditioning panel semiconductor device at a substantially uniform voltage by operating a voltage regulator and operate the driving operation of the LCD panel via the LCD driver.

The LIN transceiver may be configured to transmit signals that relate to air-conditioning condition setting and function operations input via an operation unit of the air-conditioning panel to the main controller and receive information detected when the main controller drives the air conditioner. The controller may be configured to integrally manage a standby management function of the LIN transceiver, turn on the LIN transceiver when a function the LIN transceiver is operated, and adjust an intensity of current based on the standby and wake-up of the LIN transceiver.

The device may further include: a watchdog module configured to detect an error in at least one of the controller and the LCD driver, using a watchdog timer; and a reset controller configured to restart the LCD panel by re-supplying power after stopping the power for a predetermined time based on an initializing program, when an error is detected. The reset controller may be configured to perform initialization by deleting information causing an error in a volatile memory of the controller. The reset controller may be configured to automatically start initialization in response to an error signal or semi-automatically start initialization, using a specific reset operation set.

Another exemplary embodiment of the present invention provides an air-conditioning system for a vehicle, which may include the air-conditioning panel semiconductor device configured to operate an air-conditioning panel for a vehicle described above and the system main may include: an air-conditioning panel for a vehicle configured to receive setting information and function operations for operating air-conditioning of a vehicle and display air-conditioning states based on an input; and a main controller configured to adjust an air conditioner heating or cooling air flowing into a vehicle based on setting and operations of the air-conditioning panel for a vehicle, in which the air-conditioning panel for a vehicle and the main controller may be physically separated and electrically connected via a LIN (Local Interconnect Network) transceiver.

The air-conditioning panel for a vehicle may include: an LCD panel configured to display air-conditioning states based on the operation of the air conditioner on the screen of an LCD (Liquid Crystal Display); an operation unit that may include at least one encoder switch or button switch and may be configured to receive setting information and function operations for air-conditioning control; and the air-conditioning panel semiconductor device that may be implemented in an integrated semiconductor used for an air-conditioning panel by integrating analog semiconductors and digital semiconductors in the air-conditioning panel for a vehicle. The main controller may be configured to operate an air conditioner including a blower motor to maintain a room temperature that satisfies predetermined conditions, when an operation signal of the air-conditioning panel for a vehicle is input via the LIN transceiver.

### BRIEF DESCRIPTION OF THE DRAWINGS

FIG. 1 is an exemplary block diagram showing the configuration integrating an LCD panel controller and a main controller for the type of a vehicle of the related art;

FIG. 2 is an exemplary block diagram schematically showing an air-conditioning system for a vehicle according to an exemplary embodiment of the present invention; and

FIG. 3 is an exemplary block diagram showing the configuration of a panel semiconductor unit according to an exemplary embodiment of the present invention.

Description of symbols

| | |
|---|---|
| 100: air-conditioning panel for a vehicle | 200: main controller |
| 110: LCD panel unit | 120: operation unit |
| 130: panel semiconductor unit | 121: controller |
| 132: reset controller | 133: watchdog module |
| 134: SPI | 135: motor driver |
| 136: LCD driver | 137: LIN transceiver module |
| 138: voltage regulator module | |

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit/control module refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit/control module or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

In the following detailed description, certain exemplary embodiments of the present invention have been shown and described, simply by way of illustration. As those skilled in the art would realize, the described exemplary embodiments may be modified in various different ways, all without departing from the spirit or scope of the present invention. Accordingly, the drawings and description are to be regarded as illustrative in nature and not restrictive. Like reference numerals designate like elements throughout the specification. In addition, the terms “-er”, “-or” and “module” described in the specification mean units for processing at least one function and operation and can be implemented by hardware components or software components and combinations thereof.

An air-conditioning panel semiconductor device according to an exemplary embodiment of the present invention and an air-conditioning system including the device will be described hereafter in detail with the drawings.

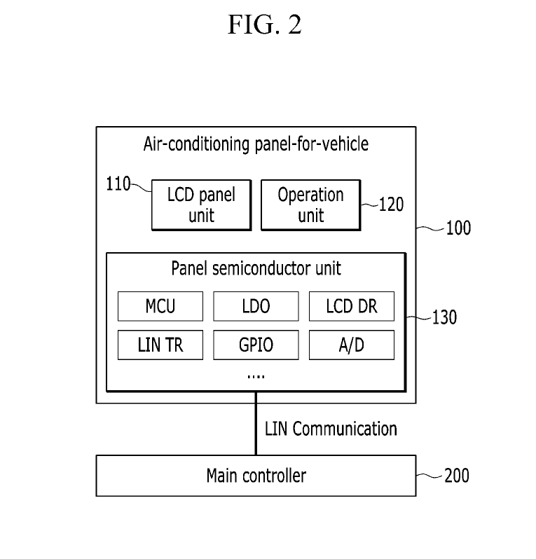

FIG. 2 is an exemplary block diagram schematically showing an air-conditioning system for a vehicle according to an exemplary embodiment of the present invention. Referring to FIG. 2, an air-conditioning system for a vehicle according to an exemplary embodiment of the present invention may include an air-conditioning panel for a vehicle 100 and a main controller 200.

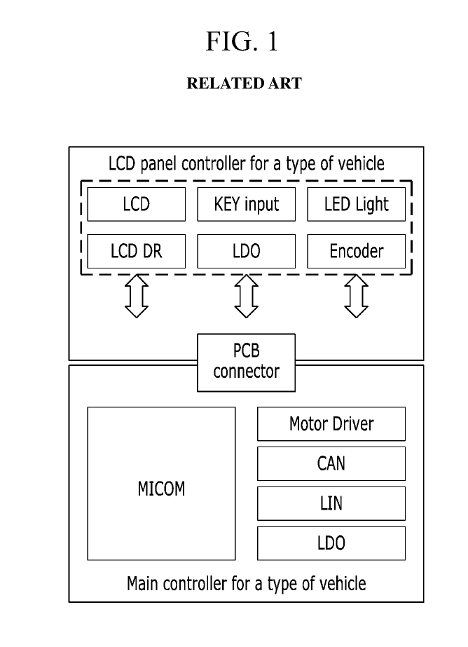

The air-conditioning panel for a vehicle 100 may be configured to receive desired setting information and operations from a driver to operate air-conditioning in a vehicle and display the air-conditioning states based on the input. The main controller 200 may be configured to adjust an air conditioner that heats and cools air flowing into a vehicle based on the setting and operation of the air-conditioning panel for a vehicle 100 by the driver. The air-conditioning panel-for-vehicle 100 and the main controller 200 may not be integrated, but may be separated, as shown in FIG. 1, and electrically connected by LIN (Local Interconnect Network) communication.

When an operation signal of the air-conditioning panel for a vehicle 100 is input via the LIN communication, the main controller 200 may be configured to operate the air conditioner that includes a compressor, a condenser, an evaporator, and a blower motor, which are not shown in the figures, to maintain the room temperature that satisfies the set conditions. Further, the main controller 200 may be configured to transmit the information regarding driving of the air conditioner to other systems within a vehicle operated in connection with the driving of the air conditioner and information detected in the process of operating the air conditioner.

Though not shown in the figures, the air conditioner may be operated to heat or cool the air within or exterior to a vehicle and supply the air in at least one of a vent mode, a floor mode, a bi level mode, and a defrost mode, by the main controller 200. Further, the air conditioner may have an external air inlet, an internal air inlet, and a plurality of discharge ports DEF, VENT, and FLOOR and an internal/external air door driven by an actuator may be disposed at the diverging point of the external air inlet and the internal air inlet, such that the external air or the internal air may be suctioned or the external air and the internal air may be mixed and suctioned.

The air-conditioning panel for a vehicle 100 may include an LCD panel 110, and operation unit 120, and a panel semiconductor 130. The LCD panel 110 may be configured to display the overall state information based on the operation of the air conditioner for a vehicle, via an LCD screen. The LCD panel 110 may be configured to display the information on various operation modes, temperature setting information regarding air-conditioning operation, and the information regarding temperature measured outside. The operation unit 120 may include various operation sets for operating the air-conditioning operation, such as at least one encoder switch Encoder SW and button switch, and may be configured to receive condition setting and function operation signals for vehicle air-conditioning operation from a user.

For example, the operation unit 120 may include a temperature control switch for setting a desired temperature within a vehicle, an airflow control switch for setting the amount of air to be blown by a fan, an air conditioner switch for setting operation of stop of an air conditioner (compressor), an internal/external air switch for setting the flow of the air within a vehicle and the external air, a discharge mode switch for changing the discharge mode of an air, a defrost switch for removing moisture from the windows of a vehicle, and an auto switch for setting the automatic operation state of the air conditioner.

The panel semiconductor unit 130 may be implemented in an integrated semiconductor for an air-conditioning panel by integrating the analog semiconductor and the digital semiconductor of an air-conditioning panel. In other words, the panel semiconductor unit 130 may be implemented in an integral unit by integrating a low drop output regulator LDO that is an existing analog semiconductor, an LCD driver DR, a LIN transceiver TR, and a Micom that is a digital semiconductor. Accordingly, by developing a semiconductor for common use based on architecture obtained by integrating the individual control semiconductors for the analog part and the digital part used in an existing air-conditioning panel and by making the hardware and the software for common use and standardizing them, it may be possible to reduce the size and the development period of a controller to thus reduce costs.

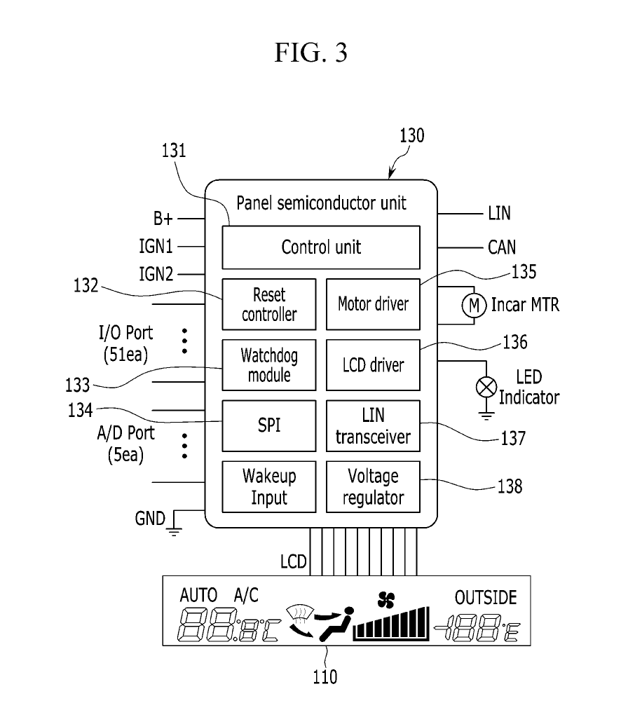

Moreover, the detailed configuration of the panel semiconductor 130 of the present invention is described hereafter with reference to FIG. 3. FIG. 3 is an exemplary block diagram showing the configuration of a panel semiconductor according to an exemplary embodiment of the present invention. Referring to FIG. 3, the panel semiconductor 130 may include a controller 131, a reset controller 132, a watchdog module 133, an SPI (Serial Peripheral Interface Bust) 134, a motor driver 135, an LCD driver 136, an LIN transceiver 137, and a voltage regulator 138.

The controller 131, which may be a microprocessor for operating the air-conditioning panel for a vehicle 100, generally may be configured to operate the analog module (analog part) and the digital module (digital part) in the panel semiconductor 130. The controller 131 may improve current efficiency by operating the voltage regulator 138 and may be configured to supply substantially uniform voltage of power for the modules in the panel semiconductor 130. In particular, it may be possible to control in detail the current for the LIN transceiver 137 and to reduce the package size by removing the existing peripheral circuit for operating the voltage regulator 138.

Furthermore, the controller 131 may be configured to operate the LCD panel 110 by operating the LCD driver 136, in which it may be possible to stably operate the LCD panel 110 by adding a diagnosis function for the LCD driver 136. Additionally, it may be possible to reduce the package size by removing the existing peripheral circuit for operating the LCD driver 136. The reset controller 132 may be configured to initialize operation to solve a problem due to an error in the controller 131 or the LCD driver 136 through self-diagnosis. The reset controller 132 may be configured perform initialization by deleting the information that causes an error in the volatile memory in the controller 131 and restart the LCD panel 110 by re-supplying power after cutting the power for a predetermined time based on an initializing program. The reset controller 132 may be configured to start initializing automatically by sensing an error signal of the controller 131 or the LCD driver 136 or may semi-automatically operate through a specific reset set (e.g., button).

The watchdog module 133 may be configured to sense an error by detecting whether the controller 131 or the LCD driver 136 operates normally (e.g., without error) using a watchdog timer. The watchdog module 133 may be configured to transmit an error signal to the reset controller 132, when an error is detected. The SPI 134 may be an interface that transmits and receives relating signals by connecting the controller 131 with an external peripheral device. For example, the SPI 134 may be configured to receive a signal for reference in air-conditioning control from a sensor such as a temperature sensor extraneous to or within a vehicle or may be configured to transmit an operation signal relating to the operation of an air conditioner to the controller of the air conditioner and receive a corresponding operation state signal. Further, the SPI 134 may be configured to receive an operation signal through connection with the operation unit 120.

The motor driver 135 may be executed by the controller 131 to operate a motor in an air-conditioning duct and operate a motor with the voltage applied based on difference between a predetermined temperature within a vehicle and a temperature measured within the vehicle. The LCD driver 136 may be executed by the controller 131 to display the operation state information of the air conditioner for a vehicle on the screen of the LCD panel, using characters and images.

The LIN transceiver 137 may be connected with the main controller 300, to transmit air-conditioning condition setting and function operation signals input through the operation unit 120 to the main controller and receive information detected when the main controller 300 drives the air conditioner. The LIN transceiver 137 may minimize current consumption through a standby mode (e.g., only 15 mA is consumed in the standby mode). For example, the controller 131 may be configured to integrally manage standby management functions of the LIN transceiver module 137, and if necessary, perform wakeup, and may control in detail the current based on the standby mode and the wakeup.

The voltage regulator 138, an LDO (Low Drop Output) regulator, may be executed by the controller 131 to stabilize power for the modules in the panel semiconductor 130 into substantially uniform output by regulating the power at a constant voltage regardless of a load current, an input voltage, and the surrounding temperature.

As described above, according to an exemplary embodiment of the present invention, it may be possible to reduce the cost with reduction of the size and the development period of a vehicle air-conditioning control package by making hardware H/W and software S/W for common use and standardizing them, by providing an integrated exclusive semiconductor device based on architecture by integrating LDO, LCD, DR, and LIN TR that are analog semiconductors and Micom that is a digital semiconductor in an air-conditioning panel for a vehicle. Further, since the semiconductor device exclusively used for an air-conditioning panel may individually adjust the currents for the LCD driver, the voltage regulator, and the LIN transceiver, it may be possible to remove the peripheral circuit and reduce the entire package size. Additionally, since the semiconductor device may be exclusively used for an air-conditioning panel and the main controller may be physically separated and connected by LIN communication, it may be possible to solve the problem of a deficit of package space due to integration of an air-conditioning switch panel and a controller in the related art.

While this invention has been described in connection with what is presently considered to be exemplary embodiments, it is to be understood that the invention is not limited to the disclosed embodiments, but, on the contrary, is intended to cover various modifications and equivalent arrangements included within the spirit and scope of the accompanying claims.

What is claimed is:

1. An air-conditioning panel semiconductor device controlling an air-conditioning panel for a vehicle, the device comprising:
a controller configured to:
integrally operate analog modules and digital modules in the air-conditioning panel semiconductor device;
operate a motor in an air-conditioning duct;
display operation state information of an air conditioner for the vehicle on a liquid crystal display (LCD) screen of an air-conditioning panel;
an SPI (Serial Peripheral Interface Bus) configured to transmit and receive signals relating to air-conditioning by connecting the controller with an external peripheral device; and
a LIN (Local Interconnect Network) communication module electrically connected with a main controller to operate the air conditioner,
wherein the controller is configured to supply power for the modules in the air-conditioning panel semiconductor device at a substantially uniform voltage by operating a voltage regulator.

2. The device of claim 1, wherein the LIN transceiver is configured to transmit signals relating to air-conditioning condition setting and function operations input through an operation unit of the air-conditioning panel to the main controller and receive information detected when the main controller drives the air conditioner.

3. The device of claim 1, wherein the controller is configured to integrally manage a standby management function of the LIN transceiver, turn on the LIN transceiver when a function the LIN transceiver is operated, and adjust an intensity of current based on the standby and turn on of the LIN transceiver.

4. The device of claim 1, further comprising:
a watchdog module executed by the controller to detect an error in at least one of the controller using a timer; and
a reset controller configured to restart the LCD panel by re-supplying power after stopping the power for a predetermined time based on an initializing program, when an error is detected.

5. The device of claim 4, wherein the reset controller is configured to perform initialization by deleting information causing an error in a volatile memory of the controller.

6. The device of claim 4, wherein the reset controller is configured to automatically start initialization in response to an error signal or semi-automatically starts initialization, using a specific reset operation set.

7. An air-conditioning system for a vehicle, which includes the air-conditioning panel semiconductor device controlling an air-conditioning panel for a vehicle of claim 6, wherein:
the air-conditioning panel for the vehicle is configured to receive setting information and function operations to operate air-conditioning of he vehicle and display air-conditioning states based on the input,
the main controller is configured to operate an air conditioner heating or cooling air flowing into a vehicle based on setting and operations of the air-conditioning panel for the vehicle, and
the air-conditioning panel for the vehicle and the main controller are physically separated and electrically connected via the LIN (Local Interconnect Network) transceiver.

8. The system of claim 7, wherein the air-conditioning panel for the vehicle includes:
an LCD panel configured to display air-conditioning states based on the operation of the air conditioner on the screen of the LCD (Liquid Crystal Display);
an operation unit that includes at least one encoder switch or button switch and is configured to receive setting information and function operations for air-conditioning operation, and
the air-conditioning panel semiconductor device that is implemented in an integrated semiconductor used for an air-conditioning panel by integrating analog semiconductors and digital semiconductors in the air-conditioning panel for the vehicle.

9. The system of claim 7, wherein the main controller is configured to operate the air conditioner including a blower motor to maintain a room temperature that satisfies predetermined conditions, when an operation signal of the air-conditioning panel for the vehicle is input via the LIN transceiver.

10. A non-transitory computer readable medium containing program instructions executed by a controller, the computer readable medium comprising:
program instructions that integrally operate analog modules and digital modules in the air-conditioning panel semiconductor device;
program instructions that operate a motor in an air-conditioning duct;
program instructions that display operation state information of an air conditioner for the vehicle on a liquid crystal display (LCD) screen of an air-conditioning panel;
program instructions that control an SPI (Serial Peripheral Interface Bus) configured to transmit and receive signals relating to air-conditioning by connecting the controller with an external peripheral device; and
program instructions that control a LIN (Local Interconnect Network) communication module electrically connected with a main controller to operate the air conditioner,
program instructions that supply power for the modules in the air-conditioning panel semiconductor device at a substantially uniform voltage by operating a voltage regulator.

11. The non-transitory computer readable medium of claim 10, further comprising:
program instructions that control the LIN transceiver to transmit signals relating to air-conditioning condition setting and function operations input through an operation unit of the air-conditioning panel to the main controller and receive information detected when the main controller drives the air conditioner.

12. The non-transitory computer readable medium of claim 10, further comprising:
program instructions that integrally manage a standby management function of the LIN transceiver, turn on the LIN transceiver when a function the LIN transceiver is operated, and adjust an intensity of current based on the standby and turn on of the LIN transceiver.
